(19) United States
(12) Patent Application Publication
(10) Pub. No.: US 2025/0263016 A1
(43) Pub. Date: Aug. 21, 2025

(54) VEHICLE SIDE MIRROR AND LOWER UNIT THEREOF

(71) Applicant: TOYOTA JIDOSHA KABUSHIKI KAISHA, Aichi-ken (JP)

(72) Inventors: Keiji ISHIMOTO, Okazaki-shi (JP); Nobuyuki SHIGEOKA, Toyota-shi (JP)

(21) Appl. No.: 19/048,974

(22) Filed: Feb. 10, 2025

(30) Foreign Application Priority Data
Feb. 16, 2024 (JP) 2024-022346

(51) Int. Cl. B60R 1/00; B60Q 1/24; B60Q 1/26; B60Q 1/34; B60R 1/12

(52) U.S. Cl. CPC B60R 1/006; B60Q 1/247; B60Q 1/249; B60Q 1/2607; B60Q 1/34; B60R 1/1207; B60R 2001/1253

(57) ABSTRACT

A lower unit of a vehicle side mirror is applicable to first and second side mirrors. The lower unit includes a common lower cover and at least one common electrical component fixed to the common lower cover. The first side mirror includes first body that holds first mirror, and first upper cover that covers an upper side of the first body from a front side of first vehicle. The common lower cover covers a lower side of the first body from the front side of the first vehicle. The second side mirror includes second body that holds second mirror having a different size from the first mirror, and second upper cover that covers an upper side of the second body from a front side of second vehicle. The common lower cover covers a lower side of the second body from the front side of the second vehicle.

### CROSS REFERENCE TO RELATED APPLICATION

This application claims priority to Japanese Patent Application No. 2024-22346 filed on Feb. 16, 2024, which is incorporated herein by reference in its entirety including the specification, claims, drawings, and abstract.

### TECHNICAL FIELD

This disclosure relates to a vehicle side mirror and a lower unit thereof.

### BACKGROUND

An automobile has side mirrors for rearward visibility. Patent Literature 1 (JP 2015-24775 A) discloses a structure of a vehicle door mirror with a side turn lamp in order to make a light source of the side turn lamp replaceable.

### CITATION LIST

### Patent Literature

PATENT LITERATURE 1: JP 2015-24775 A

### SUMMARY

Vehicle side mirrors are part of the design of a vehicle. With so many different types of vehicles being released onto the market, there is a demand for changes to the design of vehicle side mirror. In addition, according to the legal regulations regarding vehicles, the required size of the mirror (mirror surface) differs depending on the specifications of the vehicles, etc. On the other hand, there is also a demand for the development of vehicle side mirrors to be made more efficient by using common parts for multiple types of vehicles.

An object of the present disclosure is to enable the design and size of a vehicle side mirror to be changed while using a common unit that includes a part of the housing (lower cover).

A lower unit of a vehicle side mirror according to the present disclosure is applicable to first and second side mirrors. The lower unit includes a common lower cover and at least one common electrical component fixed to the common lower cover. The first side mirror includes a first body that holds a first mirror, and a first upper cover that covers an upper side of the first body from a front side of a first vehicle. The common lower cover covers a lower side of the first body from the front side of the first vehicle. The second side mirror includes a second body that holds a second mirror having a different size from the first mirror, and a second upper cover that covers an upper side of the second body from a front side of a second vehicle. The common lower cover covers a lower side of the second body from the front side of the second vehicle.

In the lower unit of a vehicle side mirror according to the present disclosure, the first mirror and the second mirror may have the same width, and the first mirror may have a smaller height than the second mirror.

In the lower unit of a vehicle side mirror according to the present disclosure, the first side mirror may be attached to the first vehicle at a first height above a road surface. The second side mirror may be attached to the second vehicle, which is different from the first vehicle, at a second height above the road surface. The first height may be lower than the second height.

In the lower unit of a vehicle side mirror according to the present disclosure, the at least one common electrical component may include at least one of a side turn signal lamp, a camera, an infrared floodlight, and a foot lighting device.

A vehicle side mirror according to the present disclosure includes the lower unit described above.

According to the present disclosure, the lower unit is used in common for multiple side mirrors, and the design and mirror size of the side mirror can be changed by changing the body and the upper cover.

### BRIEF DESCRIPTION OF DRAWINGS

Embodiments of the present disclosure will be described based on the following figures, wherein:

FIG. 1A is a front view of a side mirror.

FIG. 1B is a front view of another side mirror.

FIG. 1C is a front view of yet another side mirror.

FIG. 2A is a perspective view showing the back of a side mirror.

FIG. 2B is a perspective view showing the back of another side mirror.

FIG. 3 is an exploded perspective view of a side mirror.

FIG. 4A shows the position of the side mirrors on a vehicle.

FIG. 4B shows the position of the side mirrors on another vehicle.

### DESCRIPTION OF EMBODIMENTS

The embodiments of the present disclosure are described below based on the drawings. The present disclosure is not limited to the embodiments described herein. In all drawings, identical elements are marked with the same symbol and redundant explanations are omitted. In the following description, unless otherwise specified, the terms indicating the front-rear, right-left, and up-down, etc. directions indicate the directions related to a vehicle. In each figure, the direction of the arrow FR indicates a forward direction, the direction of the arrow UP indicates an upward direction, and the direction of the arrow RH indicates a rightward direction.

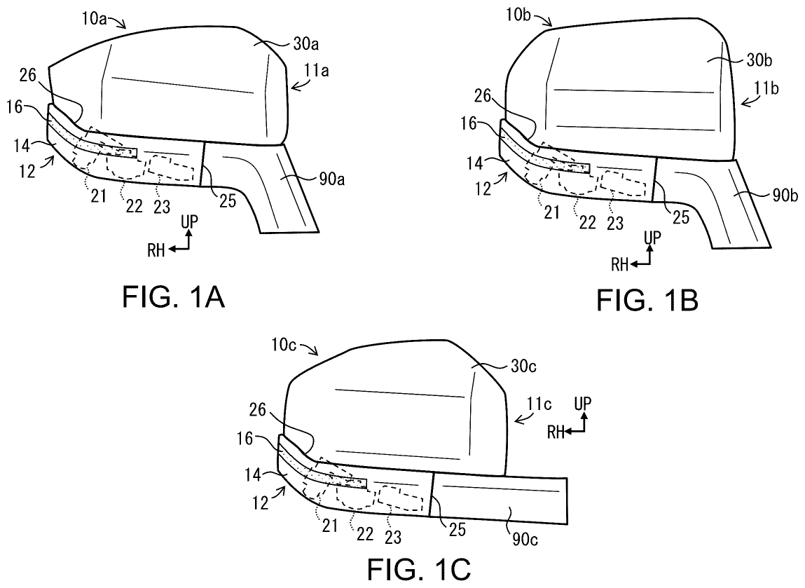

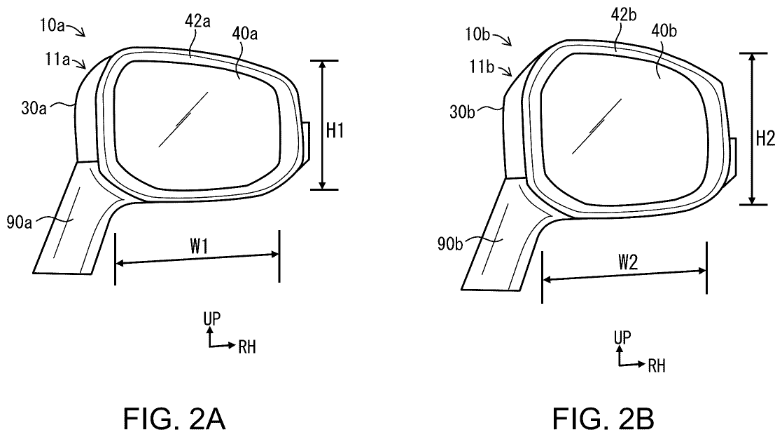

FIG. 1A is a front view of a side mirror 10a. FIG. 1B is a front view of another side mirror 10b. FIG. 1C is a front view of yet another side mirror 10c. FIG. 2A is a perspective view showing the back of the side mirror 10a. FIG. 2B is a perspective view showing the back of the side mirror 10b. The perspective view showing the back of the side mirror 10c is omitted. The side mirrors 10a, 10b, and 10c are used on automobiles as vehicles.

The side mirror 10a includes the mirror assembly 11a. The side mirror 10a is installed on passenger cars such as sedans. The mirror assembly 11a has the small-sized mirror 40a (see FIG. 2A).

The side mirror 10b includes the mirror assembly 11b. The side mirror 10c includes the mirror assembly 11c. The side mirror 10b and the side mirror 10c are installed on SUVs (Sport Utility Vehicles), which have a higher vehicle height than passenger cars. The mirror assembly 11b has the medium-sized mirror 40b (see FIG. 2B). The mirror assembly 11c also has the medium-sized mirror 40c (not shown).

As shown in FIG. 1, the lower unit 12 is used in common for the multiple mirror assemblies 11a, 11b, and 11c. The designs and sizes of the upper covers 30a, 30b, and 30c and the bodies 42a, 42b, and 42c (42c is not shown) differ between the multiple mirror assemblies 11a, 11b, and 11c.

The component structure of the multiple side mirrors 10a, 10b, and 10c is basically the same. The following explanation focuses on the side mirror 10a. The differences between the side mirrors 10b and 10c and the side mirror 10a are explained.

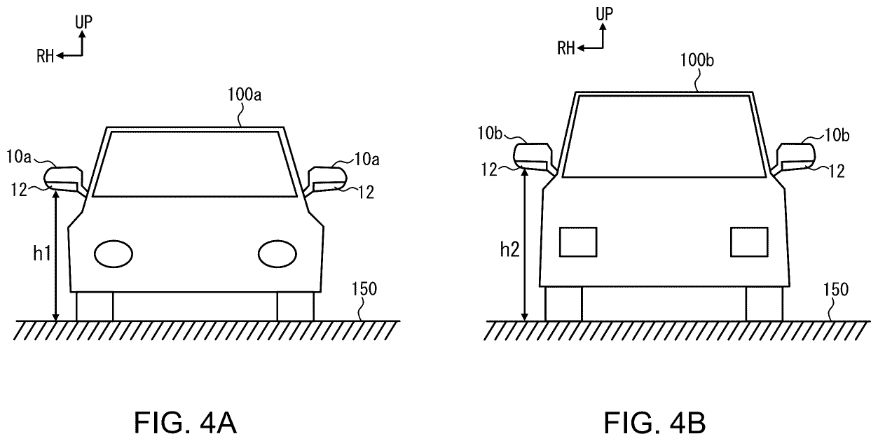

As shown in FIG. 4A, the side mirror 10A is a door mirror attached to the front doors on both the right and left sides of automobile 100A and is used primarily for rearward visibility. The following explanation refers to the right-hand side mirror 10a, and the explanation of the left-hand side mirror 10a is omitted because it has a symmetrical structure to the right-hand side mirror 10a.

As shown in FIG. 1A, the side mirror 10a includes the mirror base 90a that is fastened to the door, and the mirror assembly 11a attached to the mirror base 90a. The mirror assembly 11a is supported by the mirror base 90a, and the mirror assembly 11a can be rotated in the horizontal direction on the mirror base 90a. The mirror assembly 11a is positioned in one of two positions: the upright position (use position, see FIG. 1A), in which it protrudes laterally from the door, and the stowed position (not shown), in which it is stored on the door side.

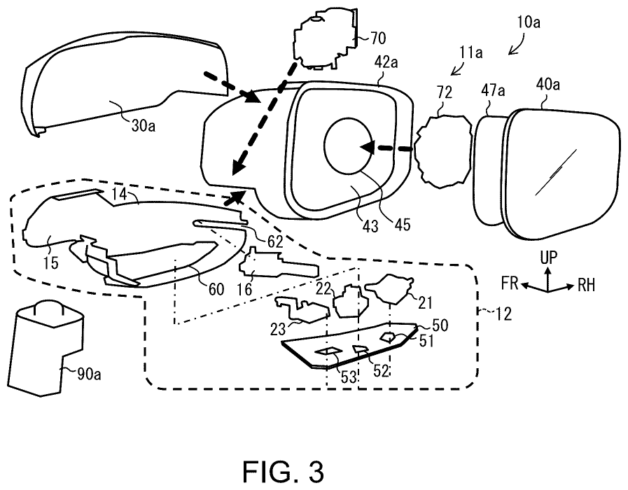

FIG. 3 is an exploded perspective view of the side mirror 10a. FIG. 3 shows the shape of each component in outline. The mirror assembly 11a includes the lower unit 12, the upper cover 30a, and the body 42a. The lower unit 12 includes the common lower cover 14.

The mirror housing is composed of the common lower cover 14, the upper cover 30a, and the body 42a. The body 42a holds the mirror 40a. The upper cover 30a covers an upper side of the body 42a from the front side of the vehicle. The common lower cover 14 covers a lower side of the body 42a from the front side of the vehicle. The upper cover 30a and the common lower cover 14 overlap each other in part. Part of the upper cover 30a is overlapped on the body 42a and engaged with the body 42a. Part of the common lower cover 14 is overlapped on the body 42a and engaged with the body 42a.

The common lower cover 14 includes the lower cover main body 15 and the panel 50 (small cover). The camera 21, the infrared floodlight 22, and the foot lighting device 23 are fixed to the upper surface of the panel 50. The lower cover main body 15 has the opening 60. The panel 50 is attached to the lower cover main body 15 so as to cover the opening 60 of the lower cover main body 15. The panel 50 is part of the underside of the common lower cover 14.

The lower unit 12 includes the side turn signal lamp 16, the camera 21, the infrared floodlight 22, and the foot lighting device 23.

The side turn signal lamp 16 has a light source such as an LED inside, and the light emitted from that light source is radiated outside through a light-emitting part made of transparent plastic. The lower cover main body 15 has a slit 62. The side turn signal lamp 16 is placed at the slit 62 from the inside of the lower cover main body 15 and fixed to the lower cover main body 15.

The camera 21 is used for a surveillance of the area around the vehicle. The camera 21 may be used for displaying a bird's-eye view of the vehicle on the in-vehicle display (Panoramic View Monitor Function). The camera 21 may be used for automatic parking function. The Panoramic View Monitor Function assists driving at low speeds by combining the images from the forward, side and rear cameras mounted on the vehicle and displaying a composite image on the display, as if seen from above the vehicle. The camera 21 may be a side camera that assists with driving at low speeds. In addition, the camera 21 may be capable to acquire the images in two regions: the visible light region (daytime) and the infrared light region (nighttime).

The infrared floodlight 22 emits infrared light to the side of the vehicle to assist the camera 21 (the camera capable of detecting infrared light) in acquiring images in dark environments at night.

The foot lighting device 23 illuminates the area around the feet of occupant (the road surface next to the vehicle) when he/she is getting in and out of the vehicle.

Each of the camera 21, the infrared floodlight 22, and the foot lighting device 23 includes a device main unit and a bracket that supports the device main unit. The brackets for the camera 21, the infrared floodlight 22, and the foot lighting device 23 are fixed to the upper surface of the panel 50. The panel 50 has a flat plate shape. The panel 50 has windows 51, 52, and 53. The camera 21 is aligned with the window 51 and positioned on the panel 50 so that the imaging section of the camera 21 is exposed through the window 51. The infrared floodlight 22 is aligned with the window 52 and positioned on the panel 50 so that the light-emitting part of the infrared floodlight 22 is exposed through the window 52. The foot lighting device 23 is aligned with the window 53 and positioned on the panel 50 so that the lighting from the foot lighting device 23 is projected through the window 53.

As shown in FIG. 3, the mirror assembly 11a includes the mirror 40a, the mirror holder 47a, the angle adjustment device 72, and the retraction device 70. The mirror holder 47a holds the mirror 40a. The mirror holder 47a is attached to the angle adjustment device 72. The angle adjustment device 72 rotates the mirror holder 47a in the vertical and horizontal directions around a predetermined position using a motor drive to adjust the mirror surface angle of the mirror 40a.

The body 42a has a concave section at the back side of the vehicle, and the bottom of the concave section is the flat panel 43. The hole 45 is formed in the flat panel 43. The mirror holder 47a and the mirror 40a are positioned in the concave section of the body 42a. The angle adjustment device 72 is positioned in front of the flat panel 43 in the direction of the vehicle. The angle adjustment device 72 and the mirror holder 47a are connected to each other through the hole 45.

The retraction device 70 rotates the mirror assembly 11a relative to the mirror base 90a using a motor drive to move the mirror assembly 11a between the use position and the stowed position. The retraction device 70 is located in front of the flat panel 43 in the direction of the vehicle. The retraction device 70 is connected to the body 42a and the mirror base 90a. The technology of conventional side mirrors (door mirrors) may be used for the side mirror 10a.

Here, the differences between the mirror assembly 11a of the side mirror 10a, as explained above, and the mirror assembly 11b of the side mirror 10b, as shown in FIG. 1B are explained. As shown in FIG. 2A, the mirror 40a of the mirror assembly 11a is a small size, while, as shown in FIG. 2B, the mirror 40b of the mirror assembly 11b is a medium size. In other words, the mirror 40b is larger than the mirror 40a. In the mirror assembly 11b, the body 42b and the upper cover 30b are larger than those of the mirror assembly 11a (the body 42a and the upper cover 30a) in order to hold the relatively large mirror 40b.

In the following, the size of width direction of mirror (mirror surface) etc. is referred to as the “W dimension”, and the size of height direction of the mirror (mirror surface) etc. is referred to as the “H dimension”. The W dimensions of mirrors 40a and 40b (mirror surfaces) and the H dimensions of mirrors 40a and 40b (mirror surfaces) are regulated by automobile regulations. The higher the driver's eye level, the larger the H dimensions of mirrors 40a and 40b needs to be. On the other hand, the W dimensions of mirrors 40a and 40b do not need to be changed significantly depending on the vehicle.

In this embodiment, the W dimensions of mirrors 40a and 40b are standardized to be the same as the largest size required among the mirror assemblies for multiple vehicle types. The W dimensions of mirror 40a (W1) and mirror 40b (W2) are the same (W1=W2). On the other hand, the H dimension of mirror 40b (H2) is larger than the H dimension of mirror 40a (H1) (H2>H1).

The W dimension of the body 42a of the mirror assembly 11a and the W dimension of the body 42b of the mirror assembly 11b may be the same or almost the same. The common lower cover 14 may be configured to cover the entire width (vehicle left-right direction) of the front lower part of the body 42a, 42b. The common lower cover 14 may also be configured to cover the front lower part of the body 42a, 42b over a portion of the width.

The mirror base 90a, 90b, and 90c may be changed depending on the type of vehicle, etc.

FIG. 4A shows an automobile 100a, and FIG. 4B shows an automobile 100b. The automobile 100a is a passenger car, such as a sedan. The automobile 100b is a SUV. The height of the automobile 100b is higher than that of the automobile 100a. The eye level of the driver of the automobile 100b is higher than that of the driver of the automobile 100a. The side mirror 10a (small-sized mirror) described above is attached to the automobile 100a (vehicle) at a height of h1 above the road surface 150. The side mirror 10b (medium-sized mirror) is attached to the automobile 100b (vehicle) at a height of h2 above the road surface 150. The h2 (referred to as second height) is higher than the h1 (referred to as first height).

The side mirror 10a, the mirror 40a, the body 42a, and the upper cover 30a described above correspond to the first side mirror, the first mirror, the first body, and the first upper cover, respectively. The passenger car corresponds to the first vehicle (vehicle of first type)

The side mirror 10b, the mirror 40b, the body 42b, and the upper cover 30b described above correspond to the second side mirror, the second mirror, the second body, and the second upper cover, respectively. SUV corresponds to the second vehicle (vehicle of second type).

Each of the mirror assemblies 11a, 11b, and 11c includes the common lower unit 12, as shown in FIGS. 1A, 1B, and 1C. Specifically, each of the mirror assemblies 11a, 11b, and 11c includes the common lower cover 14 and the common electrical components. The common electrical components are the side turn signal lamp 16, the camera 21, the infrared floodlight 22, and the foot lighting device 23.

It is not necessary for all of the above-mentioned electrical components to be installed in common in multiple mirror assemblies 11a, 11b, and 11c. For example, in one mirror assembly, the foot lighting device 23 may be omitted. Also, for example, in another mirror assembly, the camera 21, the infrared floodlight 22, and the foot lighting device 23 may be omitted. The windows 51, 52, and 53 of the panel 50 (see FIG. 3) corresponding to the omitted electrical components may be blocked by plastic parts (dummy parts). The common electrical components may also include other devices that support vehicle driving and assist occupants getting in and out of the vehicle.

As shown in FIGS. 1A, 1B, and 1C, the shapes of the boundary portions (edges) 25 of the common lower covers 14 in the multiple mirror assemblies 11a, 11b, and 11c are the same. The boundary portion 25 is the boundary portion between the common lower cover 14 and the mirror base 90a (or 90b or 90c). The right parts of the mirror bases 90a, 90b, and 90c are standardized to a shape corresponding to the boundary portion 25. As shown in FIGS. 1A, 1B, and 1C, the shapes of the boundary portions (edges) 26 of the common lower covers 14 in the multiple mirror assemblies 11a, 11b, and 11c are the same. The boundary portion 26 is the boundary portion between the common lower cover 14 and the upper cover 30a (or 30b or 30c). The lower parts of the upper covers 30a, 30b, and 30c are standardized to a shape corresponding to the boundary portion 26.

The common lower cover 14 is engaged with the body 42a, 42b, and 42c (42c is not shown) using an engagement mechanism. The engagement mechanism may, for example, include engagement claws provided on one of the common lower cover 14 and the bodies 42a, 42b, 42c, and engagement holes provided on the other of the common lower cover 14 and the bodies 42a, 42b, 42c, into which the engagement claws engage. The engagement mechanism may, for example, include male threads provided on one of the common lower cover 14 and the bodies 42a, 42b, 42c, and female threads provided on the other of the common lower cover 14 and the bodies 42a, 42b, 42c, into which the male threads are screwed. There may be more than one engagement mechanism. The position and form of the engagement mechanism for engaging with the common lower cover 14 are standardized for each of the body 42a, 42b, and 42c.

Next, the effects of the embodiments described above are explained.

According to the embodiments described above, the lower units 12 are used in common for the multiple mirror assemblies 11a, 11b, 11c, which reduces the man-hours required for the development and design of the multiple mirror assemblies 11a, 11b, 11c. It is also possible to reduce the cost of toolings (molds) for making parts and the man-hours required for evaluating the multiple mirror assemblies 11a, 11b, 11c. On the other hand, by changing the design and size of the upper cover 30a, 30b, 30c and the body 42a, 42b, 42c (42c is not shown), it is possible to achieve the desired mirror assembly 11a, 11b, 11c. It is possible to create mirror assemblies with designs and sizes that match the type and specification of the vehicle.

There are many types of mirror assemblies that need to be prepared according to the types and specifications of the vehicles. In recent years, the number of types of mirror assemblies has increased because components (such as cameras) that support vehicle driving and assist occupants getting in and out of the vehicle are incorporated into the mirror assembly depending on the requirements of each vehicle. The number of types of parts incorporated into the mirror assembly has also increased. The brackets used to attach electrical components such as cameras to the mirror assembly are also redesigned according to the specifications of the mirror assembly. There are many types of parts, which are taking up space in the factory and making manufacturing less efficient.

However, according to the embodiments described above, the number of types of parts (electrical components) can be reduced because the parts are concentrated in the lower unit, and the lower unit is used in common by the multiple mirror assemblies. It is possible to reduce the space required in the factory, and manufacturing can be carried out more efficiently.

The shape, size and color of the upper cover and the body can be changed. The upper covers and the bodies can change the design and size of the side mirror. The common lower covers may have the same shape and size for each side mirror, but the color of the common lower covers may be changed.

1. A lower unit of a vehicle side mirror, the lower unit applicable to first and second side mirrors, the lower unit comprising:
a common lower cover, and
at least one common electrical component fixed to the common lower cover;
wherein the first side mirror includes:
a first body that holds a first mirror, and
a first upper cover that covers an upper side of the first body from a front side of a first vehicle; and
wherein the common lower cover covers a lower side of the first body from the front side of the first vehicle,
wherein the second side mirror includes:
a second body that holds a second mirror having a different size from the first mirror, and
a second upper cover that covers an upper side of the second body from a front side of a second vehicle; and
wherein the common lower cover covers a lower side of the second body from the front side of the second vehicle.

2. The lower unit of a vehicle side mirror according to claim 1, wherein
the first mirror and the second mirror have the same width, and
the first mirror has a smaller height than the second mirror.

3. The lower unit of a vehicle side mirror according to claim 2, wherein
the first side mirror is attached to the first vehicle at a first height above a road surface,
the second side mirror is attached to the second vehicle, which is different from the first vehicle, at a second height above the road surface, and
the first height is lower than the second height.

4. The lower unit of a vehicle side mirror according to claim 1, wherein
the at least one common electrical component includes at least one of a side turn signal lamp, a camera, an infrared floodlight, and a foot lighting device.

5. A vehicle side mirror which includes the lower unit according to claim 1.

6. A vehicle side mirror which includes the lower unit according to claim 2.

7. A vehicle side mirror which includes the lower unit according to claim 3.

8. A vehicle side mirror which includes the lower unit according to claim 4.
